(19) United States
(12) Patent Application Publication
(10) Pub. No.: US 2012/0133682 A1
(43) Pub. Date: May 31, 2012

(54) DISPLAY APPARATUS

(75) Inventors: Fujio Kawano, Kawasaki-shi (JP); Kiyofumi Sakaguchi, Mobara-shi (JP)

(73) Assignee: CANON KABUSHIKI KAISHA, Tokyo (JP)

(21) Appl. No.: 13/293,025

(22) Filed: Nov. 9, 2011

(30) Foreign Application Priority Data
Nov. 26, 2010 (JP) 2010-264219

(51) Int. Cl. G09G 5/10

(52) U.S. Cl. 345/690

(57) ABSTRACT

Provided is a display apparatus comprising light-emitting elements having colors cyclically aligned, pixel circuits and a processing circuit, the light-emitting elements each having two light-emitting regions aligned in the column direction so as to invert the positions of the two light-emitting regions in accordance with a cycle of the colors, and the two light-emitting regions having different optical characteristics and emitting light alternately over two consecutive frame periods so that the light-emitting regions which emit light in each frame period have the same optical characteristics.

### BACKGROUND OF THE INVENTION

1. Field of the Invention

The present invention relates to a display apparatus and, specifically, relates to a display apparatus including organic electroluminescent elements.

2. Description of the Related Art

An organic electroluminescent (EL) element emits light when an electric current is applied to a thin organic layer interposed between two electrodes. Such organic EL elements are arranged two-dimensionally to constitute a display apparatus.

There is a problem in that the light-extraction efficiency of organic EL elements is low. Although light is emitted in various angles from the thin light-emitting layer, total reflection occurs at the boundary surfaces of the external space and layers that sandwich the light-emitting layer, such as protective layers, causing light to be trapped inside the light-emitting element and preventing most of the light from being extracted to the external space. To solve this problem, various solutions have been proposed.

Japanese Patent Laid-Open No. 2004-039500 discloses a configuration that improves the front light-extraction efficiency by disposing a microlens (hereinafter referred to as “lenses”) made of resin on the light-emitting surface of an organic EL element. Each lens is provided for each organic EL element. Such a lens array can extract the totally reflected light to the outside, and, furthermore, part of the extracted light can be collected in a predetermined range of angle. Therefore, when such organic EL elements are used in a display apparatus, the luminance measured at the front will increase.

To improve the light-extraction efficiency, the lens diameter is set larger than the diameter of the light-emitting region. However, the lens diameter cannot be increased more than the pixel size because, when the lenses of adjacent pixels overlap, light-extraction efficiency may decrease or color mixing may occur. If the light-emitting region of an organic EL element is reduced, electric current density increases, accelerating degradation; therefore, the light-emitting region cannot be reduced too much.

FIG. 12A is a pixel layout diagram of a display apparatus illustrating light-emitting regions arranged in a staggered pattern such that the lens arrays do not overlap. Pixel circuits (for example, 31, 32, and 33) are arranged two-dimensionally. A red (R), green (G), or blue (B) organic EL element (for example, 33R, 32G, or 33B) is disposed on each pixel circuit. Lenses 110 are disposed to cover the light-emitting regions of the organic EL elements. In the drawing, although only two rows (m−1 and m) and two columns (n−1 and n) are illustrated, actually multiple organic EL elements are arranged in, for example, 640 rows and 480 columns. The longitudinal array of light-emitting elements of the same color is referred to as a sub-column, and three RGB sub-columns are collectively referred to as a column.

As illustrated in FIG. 12A, in a color display apparatus, organic EL elements of the three different colors, i.e., red (R), green (G), and blue (B), are cyclically arranged in the row direction (left-to-right direction in the drawing). A set of RGB organic EL elements constitute a pixel. The positions of light-emitting regions of the adjacent organic EL elements in the same row (e.g., 31R and 32G, or 32G and 33B) are misaligned in the column direction (top-to-bottom direction in the drawing) by a distance equal to ½ rows. In each column, three RGB light-emitting regions form a delta arrangement 51, which is a downward triangle, and the three RGB light emitting regions in the adjacent column form a delta arrangement 52, which is an upward triangle.

By disposing the light-emitting regions in an alternating pattern, such as that illustrated in FIG. 12A, a lens array can be disposed in a display apparatus having high pixel density.

Image signals that are sent to a display apparatus is often prepared with the presumption that RGB sub-pixels are arranged in a stripe pattern, such as that illustrated in FIG. 13, in which the sub-pixels are aligned in rows and sub-columns. In the stripe pattern, the centers of gravity of the pixels, each of which is constituted of a set of RGB light-emitting regions, form a square grid, and each of the RGB light-emitting regions also form a square grid.

In FIG. 12A, the RGB light-emitting regions are aligned in a delta arrangement. In a delta arrangement, when sets of three RGB sub-pixels constitute pixels in each row, the centers of gravity of the pixels form a square grid; the grid points in the grid formed by the sub-pixels of each color are displaced by a column.

If an image signal prepared on the basis of a square grid pixel arrangement, such as that illustrated in FIG. 13, is directly displayed on the display apparatus having pixels disposed in delta arrangement, such as that as illustrated in FIG. 12A, the image will be displaced in each column on the display screen. Such a displacement causes roughness at the edge of the image, and with a high-resolution display apparatus, may cause false colors and color moire, significantly reducing the display quality.

U.S. Patent No. 2002/0070909 describes a case in which the pixel arrangement illustrated in FIG. 12A is changed to that in FIG. 12B. Japanese Patent Laid-Open No. 2002-156940 describes a method of converting image data for a stripe arrangement to image data for a delta arrangement. The method of converting data in Japanese Patent Laid-Open No. 2002-156940 is applied to the pixel arrangement illustrated in FIG. 12B as described below.

In the odd numbered column (which, in this case, is column n−1), a set of RGB light-emitting regions 31R, 32G, and 33B in row m−1 constitute a pixel 10. Similarly, in the next row m, a set of RGB light-emitting regions 41R, 42G, and 43B constitute a pixel 11.

In the even numbered column (which, in this case, is column n), an R light-emitting region 34R and a B light-emitting region 36B in row m−1 and a G light-emitting region 45G in row m, which is directly below row m−1, constitute a pixel 12. A light-emitting region 35G in row m−1 and column n constitutes a pixel together with R and B light-emitting regions (not shown) in row m−2, which is right above row m−1. R and B light-emitting regions 44R and 46B in row m and column n constitute a pixel together with a G light-emitting region in row m+1 and column n.

The delta arrangement 52 disposed across rows m−1 and m forms a downward triangle, which is the same shape as the delta arrangements 51 formed by the pixels 10 and 11, each disposed in the same row. The grids formed by the centers of gravity and the light-emitting points of the different colors have grid points displaced at each column. The light-emitting points in every pixel form a delta arrangement of an upward triangle. Thus, the arrangement of the light-emitting regions is the same in every pixel in the display apparatus.

RGB data of an input image is assigned to pixels 10 to 12, which are illustrated in FIG. 12B, as described below. That is, RGB data corresponding to a pixel of the input image is directly assigned to each of the pixels 10 and 11 in the add column, whereas, RGB data corresponding to the average of two adjacent rows in the even numbered column is assigned to the pixel 12, which is disposed across the two rows.

As a result, RGB image data sets in the original image signal corresponding to the pixel in row m−1 and column n−1 are respectively assigned to the RGB light-emitting regions 31R, 32G, and 33B in the pixel 10 at row m−1 and column n−1. This is also the same for the pixel 11 at row m and column n−1.

For the pixel 12 in column n, the R light-emitting region 34R receives image data corresponding to the average of the R image data of row m−1 and column n and the R image data of row m and column n in the original image signal. Similarly, the B light-emitting region 36B and the G light-emitting region 45G each receive image data corresponding to the average of image data of row m−1 and column n and image data of row m and column n.

The G light-emitting region 35G at row m−1 and column n receives image data corresponding to the average of the G image data of row m−2 and column n and the G image data of row m−1 and column n in the original image signal. The R light-emitting region 44R at row m and column n receives image data corresponding to the average of the R image data of row m and column n and the G image data of row m+1 and column n in the original image data. This is also the same for the B light-emitting region 46B.

Through such data processing, image quality degradation, such as roughness at the edges, false colors, and color moire, can be reduced.

Compared with a display apparatus that does not have a lens array, a display apparatus having a lens array has high luminance when viewed from the front but has low luminance when viewed at an angle. Depending on the usage (user scenes) of the display apparatus, a wide view angle may be required more than high front luminance. When elements having high light-harvesting ability, such as lenses, are disposed on organic EL elements, the display apparatus will be unsuitable for use requiring a wide view angle.

To achieve both a wide view angle and high front luminance, light-emitting regions provided with lenses and light-emitting regions not provided with lenses may be combined in by disposing them side by side in a pixel. FIG. 14 illustrates the arrangement of pixels including RGB organic EL elements; the organic EL elements have two different types of light-emitting regions: one provided with a lens 110 (represented by reference characters with an upper case suffix, such as 31R, 32G, or 33B) and the other not provided with a lens (represented by reference characters with a lower case suffix, such as 31r, 32g, or 33b). Components that are the same as those in FIG. 12A are represented by the same reference numbers and characters.

The two light-emitting regions in the same row and the same sub-column (such as 31R and 31r, or 34r and 34R) are connected to the pixel circuit (such as 31 or 34). The two light-emitting regions in the same row and the same sub-column are arranged such that one is closer to the row above (such as 31R, 32g, or 33B) and the other is closer to the row below (such as 31r, 32G, or 33b). This arrangement of the two light-emitting regions is inverted in adjacent sub-columns. The arrangement of the RGB light-emitting regions in each pixel is also inverted in adjacent pixels.

Instead of lenses, by providing two different types of optical elements having different optical characteristics, such as the front luminance or the view angle-to-luminance characteristics, in the light-emitting regions and combining two light-emitting regions provided with different optical elements, a display apparatus having two different types of optical characteristics can be produced. By varying the light emittance ratio of the two light-emitting regions, the two different types of optical characteristics can be adjusted respectively.

In a display apparatus having organic EL elements that include two different types of light-emitting regions, such as that illustrated in FIG. 14, has the following problem.

In the odd numbered column (column n−1), a total of six light-emitting regions, i.e., RGB light-emitting regions 31R, 32G, and 33B, which are provided with the lenses 110, and RGB light-emitting regions 31r, 32g, and 33b, which are not provided with the lenses 110, constitute the pixel 10 in row m−1. Similarly, the light-emitting regions constitute the pixel 11 in row m. In each pixel, the light-emitting regions provided with the lenses 110 form a delta arrangement 51 of an inverted triangle, and the light-emitting regions not provided with the lenses 100 form a delta arrangement 53 of a regular triangle.

Among the RGB data sets for a pixel, the R data is sent to a pixel circuit 31 driving the light-emitting regions 31R and 31r, the G data is sent to a pixel circuit 32 driving the light-emitting regions 32g and 32G, and the B data is sent to a pixel circuit 33 driving the light-emitting regions 33B and 33b. Since the six light-emitting regions constitute one pixel in the original input image, the same data is assigned to both of the two light-emitting regions (one of which is provided with the lens 110 and the other not provided) of the same color.

In the even numbered columns (such as column n and column n+2), a set of three light-emitting regions provided with the lenses 110, i.e., the R light-emitting region 34R and the B light-emitting region 36B, which are in the same row and, and the G light-emitting region 45G, which is in the row below, constitute in the pixel 12 with a delta arrangement 52 of an inverted triangle.

The three light-emitting regions 34R, 45G, and 36B, which are provided with the lenses 110, respectively share pixel circuits with and receive the same image data as light-emitting regions 34r, 45g, and 36b, which are not provided with the lenses; the RB light-emitting region 34r and 36b are in row m−1 but the G light-emitting region 45g is in row m. The light-emitting regions 34r and 36b and the light-emitting region 45g are disposed apart from each other by a distance greater than the width of a row, and form a delta arrangement 54 of a long inverted triangle, which differs from the delta arrangement 52 formed by the three light-emitting regions 34R, 45G, and 36B, which are provided with the lenses 110. When the light-emitting regions 34r, 45g, and 36b in the long delta arrangement 54 emit light, they cause image quality degradation, such as false colors, color moire, and roughness at the image edges, causing a significant decrease in display quality.

When the light-emitting regions 44r, 35g, and 46b not provided with the lenses form a delta arrangement of a regular triangle, the light-emitting regions 44R, 35G, and 46B provided with the lenses 110 form a delta arrangement of a long inverted triangle.

### SUMMARY OF THE INVENTION

As solutions to the problems described above, the present invention provides a display apparatus including a plurality of pixel circuits arranged in a row direction and a column direction; light-emitting elements each connected to one of the pixel circuits, colors of light emitted from the light-emitting elements being cyclically aligned in the row direction; and a processing circuit configured to receive image data corresponding to the row and the columns of the pixel circuits by frame period, to process the image data, and to transmit the processed image data to the pixel circuits, wherein the light-emitting elements each have two light-emitting regions aligned in the column direction so as to invert the positions of the two light-emitting regions in accordance with the cycle of the colors, wherein the two light-emitting regions have different optical characteristics and emit light alternately over two consecutive frame periods so that the light-emitting regions which emit light in each frame period have the same optical characteristics, and wherein the processing circuit transmits to a portion of the plurality of pixel circuits positioned every two cycles of the colors image data corresponding to the row and the columns of the pixel circuits to transmit the image data, and to the pixel circuits disposed between the pixel circuits of the portion first image data obtained by mixing image data corresponding to the rows and the columns of the pixel circuits to transmit the first image data with image data corresponding to the previous rows and the same columns and second image data obtained by mixing image data corresponding to the rows and the columns of the pixel circuits to transmit the second image data with image data corresponding to the next rows and the same columns alternately over two consecutive frame periods.

With the display apparatus including organic EL elements according to the present invention, RGB sub-pixels each include two light-emitting regions having different optical characteristics, and the light-emitting regions in RGB sub-pixels having the same optical characteristics form delta arrangements; therefore, the excellent display quality is achieved. In particular, with the display apparatus in which the light-emitting regions provided with lenses and the light-emitting regions not provided with lenses each form RGB delta arrangements of oppositely oriented triangles, false colors, color moire, roughness at the image edges are prevented.

Further features of the present invention will become apparent from the following description of exemplary embodiments with reference to the attached drawings.

### BRIEF DESCRIPTION OF THE DRAWINGS

FIG. 1 illustrates the arrangement of light-emitting regions in a display apparatus according to the present invention.

FIG. 2 illustrates, in outline, a display apparatus according to an embodiment of the present invention.

FIG. 3 illustrates a pixel circuit in the display apparatus according to the present invention.

FIG. 4 illustrates an image signal input to the display apparatus.

FIG. 5 illustrates processing circuits in the display apparatus according to the present invention and the data flow.

FIG. 6 illustrates image data transmitted to a pixel circuit in the display apparatus according to the present invention.

FIG. 7 is a sectional diagram illustrating the structure of organic electroluminescent elements.

FIG. 8 is a graph illustrating the optical characteristics of organic electroluminescent elements ELA and ELB according to the present invention.

FIG. 9 is a timing chart illustrating the timing of turning on and off the display apparatus of the present invention.

FIG. 10 is a graph illustrating the change in the luminance-to-view angle characteristics of the display apparatus according to the present invention.

FIG. 11 is a graph illustrating the change in power consumption of the display apparatus according to the present invention.

FIGS. 12A and 12B illustrate the arrangement of light-emitting regions in a known display apparatus.

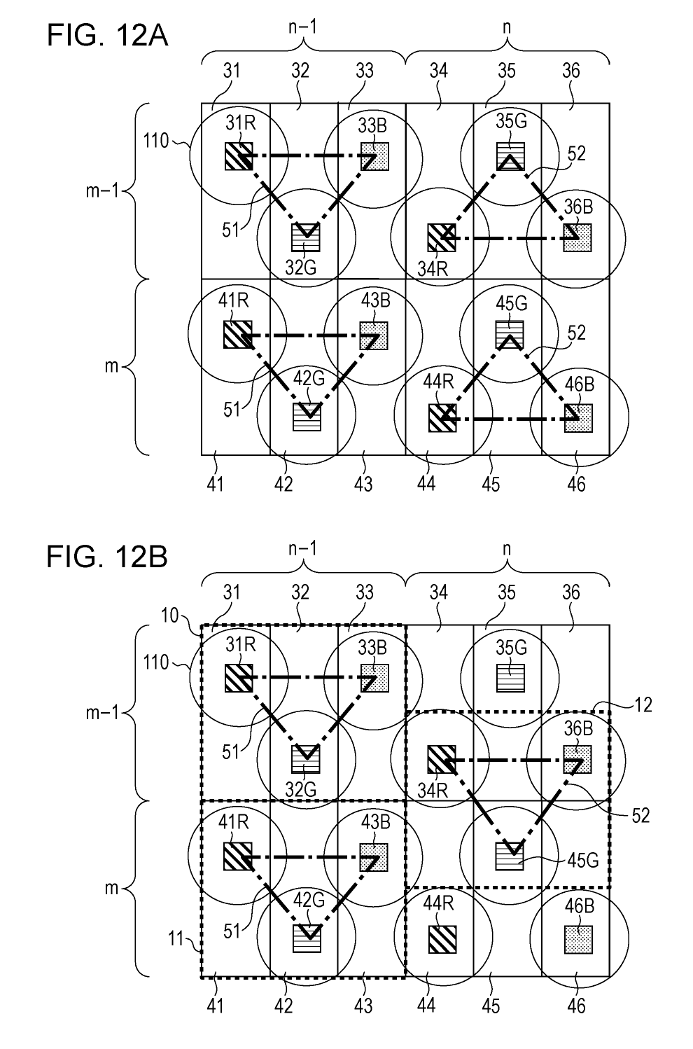

FIG. 13 illustrates the arrangement of other light-emitting regions in the known display apparatus.

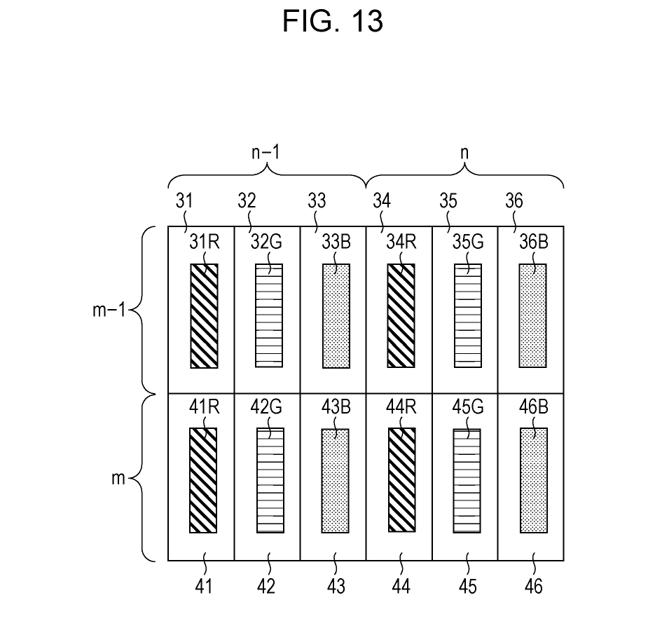

FIG. 14 illustrates a problem to be solved by the present invention.

### DESCRIPTION OF THE EMBODIMENTS

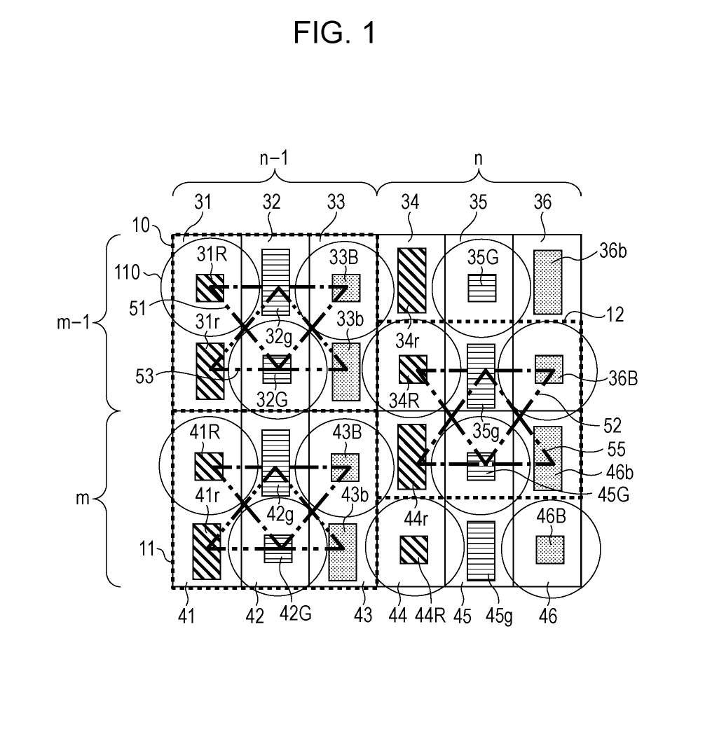

FIG. 1 illustrates the configuration of pixels in a display apparatus according to an embodiment of the present invention.

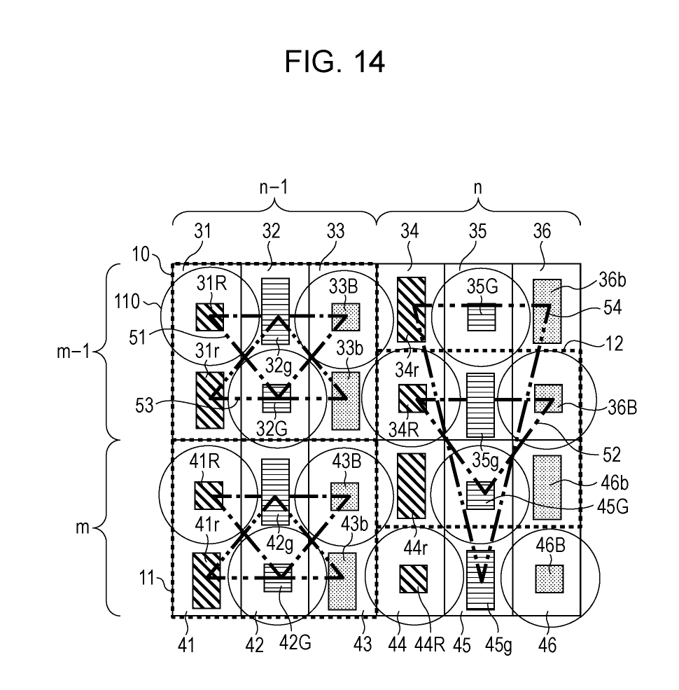

The arrangement of light-emitting regions in FIG. 1 is the same as that in FIG. 14. RGB organic electroluminescent (EL) elements are cyclically aligned in the row direction and are connected to pixel circuits 31 to 36 and 41 to 46. Organic EL elements of the same color are connected to pixel circuits in the same sub-column. Similar to FIG. 14, the three RGB sub-columns constitute a column.

The pixel circuit 31 is connected to two light-emitting regions 31r and 31R. An organic EL element ELA, which has a flat surface not including a lens, is disposed in the light-emitting region 31r (and every other light-emitting region represented by a reference number with a lower case suffix). An organic EL element ELB, which has a lens on the surface, is disposed on the light-emitting region 31R (and every other light-emitting region represented by a reference number with an upper case suffix). The positions of the organic EL elements ELA and ELB are alternately inverted in every adjacent sub-column. For organic EL elements ELA and ELB of the same color, the vertical positions of the two light-emitting regions in one column are inverted in the adjacent column.

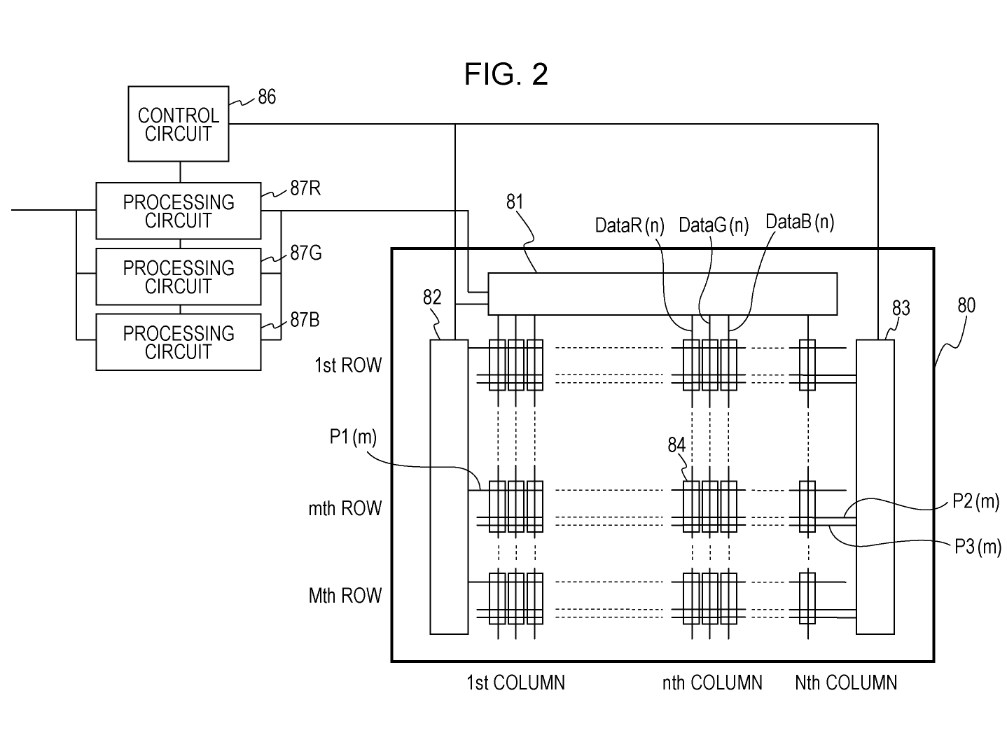

FIG. 2 illustrates the configuration of the display apparatus.

The display apparatus includes a control circuit 86, processing circuits 87R, 87G, and 87B processing an RGB image signal, and a panel 80.

On the panel 80, pixel circuits 84 are arranged in M rows and 3N sub-columns; the pixel circuits 84 aligned in the row direction are connected to RGB organic EL elements (not shown). One set of RGB organic EL elements constitute a pixel.

An image signal VIDEO that is input to the display apparatus from outside is separated into RGB signals, which are processed at the processing circuits 87R, 87G, and 87B, respectively. The image data processed at the processing circuits 87 (hereinafter, the suffixes R, G, and B are omitted when RGB are collectively referred to) is sent to a data-line driving circuit 81. The data-line driving circuit 81 sends data signals to data signal lines DataR(n), DataG(n), and DataB(n) (where n represents the column number, which is omitted when the columns are collectively referred to). The data signal lines Data transmits data signals Vdata to the pixel circuits 84.

Control lines P1 (m) (where m represents the row number, which is omitted when the rows are collectively referred to) transmits controls signals generated at a gate-line driving circuit 82 to the pixel circuits 84, and control lines P2 and P3 transmit control signals generated at a light-emission-period control circuit 83 to the pixel circuits 84.

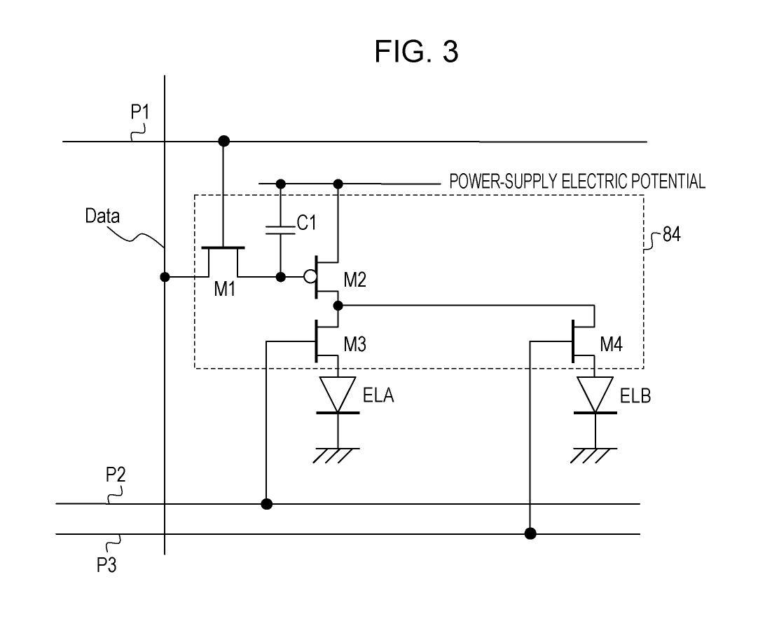

FIG. 3 is a circuit diagram illustrating one of the pixel circuits 84 and organic EL elements ELA and ELB connected to thereto. Each pixel circuit 84 is connected to an organic EL element ELA, which does not have a lens, and an organic EL element ELB, which has a lens. Since the configuration of the pixel circuits 84 are the same for all three colors, FIG. 3 only illustrates a pixel circuit connected to organic EL elements for one of the colors.

Each pixel circuit 84 is connected to a data signal line Data and control lines P1, P2, and P3. The control lines P1 sequentially select pixel circuits by row; a data signal Vdata is written in the pixel circuit 84 in the row selected by the control line P1. The control line P1 is connected to a gate terminal of a thin-film transistor (TFT) (M1). The TFT (M1) in the pixel circuit in the row selected by the control line P1 becomes conductive, and a data signal is transmitted through the data signal line DATA to a storage capacitor C1, where it is stored.

The anode electrode of the organic EL element ELA is connected to the source terminal of a TFT (M3), and the cathode electrode is connected to the ground potential CGND. The anode electrode of the organic EL element ELB is connected to the source terminal of a TFT (M4), and the cathode electrode is connected to the ground potential CGND.

The drain terminals of the TFT (M3) and TFT (M4) are integrated and are connected to the drain terminal of a TFT (M2). The source terminal of the TFT (M2) is connected to a power-supply electric potential. The source terminal of the TFT (M1) is connected to one end of the storage capacitor C1 and to the gate terminal of the TFT (M2). The other end of the storage capacitor C1 is the power-supply electric potential.

The control line P2 connected to the gate terminal of the TFT (M3) controls the illumination period of the organic EL element ELA by supplying or cutting off an electric current to or from the organic EL element ELA. The control line P3 connected to the gate terminal of the TFT (M4) controls the illumination period of the organic EL element ELB by supplying or cutting off an electric current to or from the organic EL element ELB.

When an electric current is supplied to the organic EL element ELA to illuminate the organic EL element ELA, a low level signal is input to the control line P1, a high level signal is input to the control line P2, and a low level signal is input to the control line P3. At this time, the TFT (M1) is turned off, TFT (M3) is turned on, and TFT (M4) is turned off. Since the TFT (M3) is in a conductive state, the drain current of the TFT (M2) is supplied to the organic EL element ELA by the voltage across the storage capacitor C1, causing the organic EL element ELA to illuminate with a luminance corresponding to the supplied current. The organic EL element ELA continues to illuminate while a high level signal is supplied to the control line P2. The illumination is terminated when a low level signal is supplied to the control line P2. The time integrated light quantity of the organic EL element ELA equals the apparent luminance thereof.

When an electric current is supplied to the organic EL element ELB to illuminate the organic EL element ELB, a low level signal is input to the control line P1, a low level signal is input to the control line P2, and a high level signal is input to the control line P3. At this time, the TFT (M1) is turned off, TFT (M3) is turned off, and TFT (M4) is turned on. Since the TFT (M4) is in a conductive state, an electric current corresponding to the voltage retained in the storage capacitor C1 is supplied from the drain of the TFT (M2) to the organic EL element ELB, causing the organic EL element ELB to illuminate. The integrated light quantity for the period a high level signal is input to the control line P3 equals the apparent luminance of the organic EL element ELB.

The organic EL elements ELA and ELB sharing the driving circuit receive the data signal Vdata via the same data signal line Data from the control line P1 in the same selected period. The operation of selecting a row by the control line P1 and inputting a data signal to the pixel circuit 84 in the selected row via the data signal line is referred to as “writing.” In one session of writing, the same data signal is input to the organic EL elements ELA and ELB in the same pixel circuit 84.

To illuminate the organic EL elements ELA and ELB separately by different data signals, the organic EL element ELA is illuminated by setting the control line P2 to a selection level after writing in one of data signals, rewriting the data signal, and then illuminating the organic EL element ELB by setting the control line P3 to a selection level. Normally, data is written in each row once in each frame period in which an image signal corresponding to one screen is transmitted. Thus, to switch the display of the organic EL element ELA and the organic EL element ELB, the organic EL element ELA is illuminated by writing data for the organic EL element ELA in the pixel circuit in one frame period, and then, in the next frame period, the organic EL element ELB is illuminated by writing data for the organic EL element ELB in the same pixel circuit.

By providing a switch for each of the two organic EL elements in the pixel circuit and controlling the supplied current, the two organic EL elements can be illuminated at different timings in accordance with different data sets.

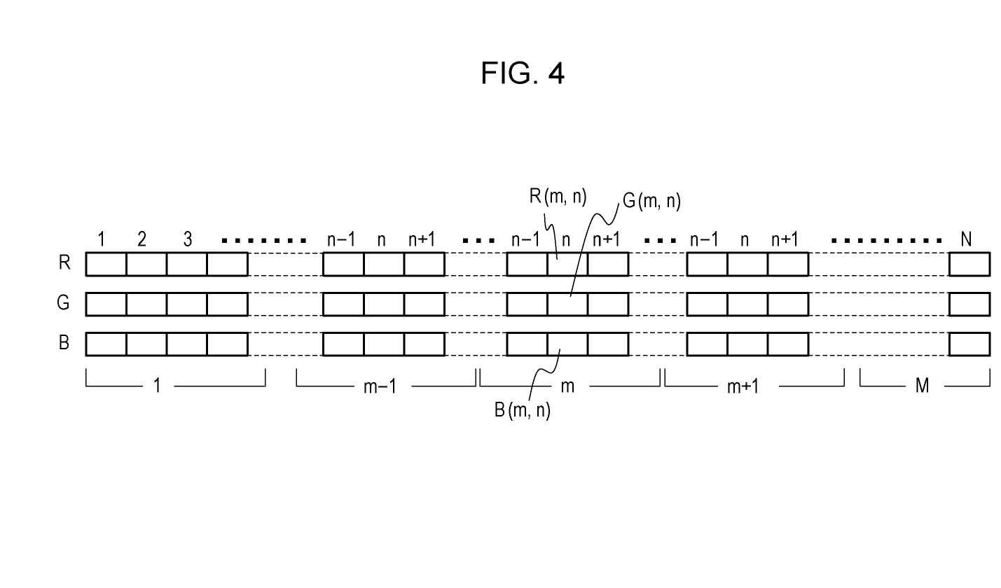

FIG. 4 illustrates an image signal input to the display apparatus from the outside. The image signal includes sets of image data R (m, n), G (m, n), and B (m, n) corresponding to the RGB pixels time-sequentially aligned in parallel in the order of m and n. In one frame period (usually 1/60 seconds), the image signal is sent as time-sequential image data sets corresponding to the first to Nth columns of the first row, the first to Nth columns of the second row, . . . , and, finally, the first to Nth column of the Mth row. The image signal in one frame period constitutes one image. Sixty images are sent every second. Although the image data is actually sent as an 8-bit digital signal, here the image data is treated as a single set of image data.

The input image signal in FIG. 4 corresponds to the RGB luminance of each section (pixel) of the square grid of the original image. In other words, the image signal contains image data to be applied to pixels arranged in a stripe pattern.

The RGB data sets in the input image signal illustrated in FIG. 4 are sent to the processing circuits 87R, 87G, and 87B, respectively, and are converted by the data-line driving circuit 81 to data signals sent to the data signal lines.

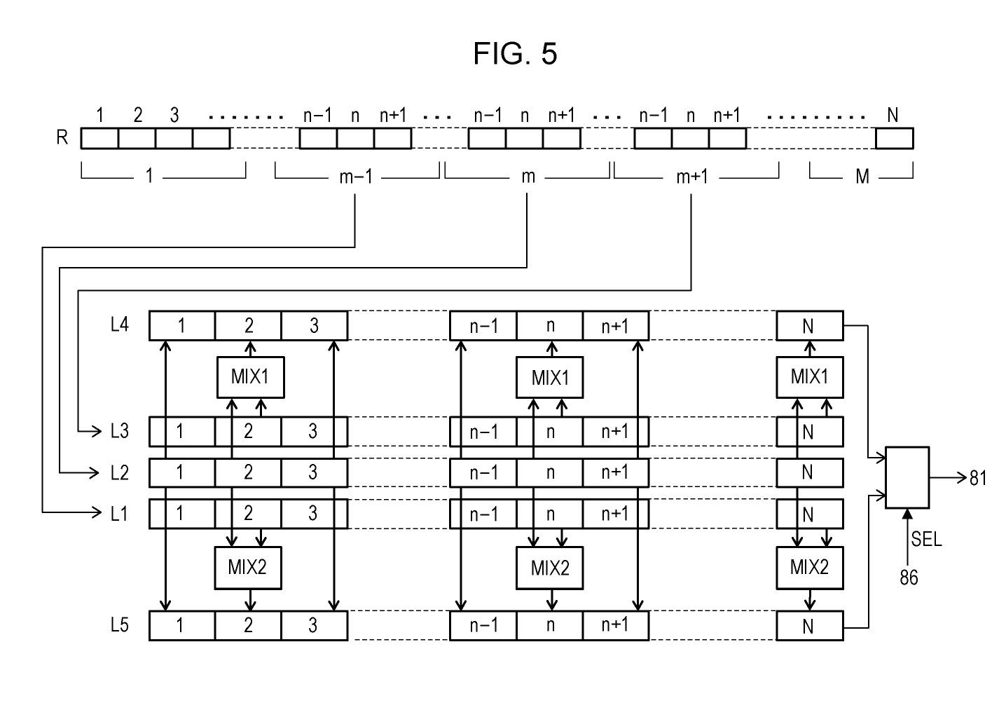

FIG. 5 illustrates the configuration of one of the processing circuits 87 for processing image data. Since the processing circuit 87 for each color is the same, only the processing circuit 87R for red (R) illustrated.

The processing circuit 87 includes line memories L1 to L3 in which three rows of the input image signal R(1,1)-R(M,N) are stored; a mixer MIX1 for mixing image data sets corresponding to the even numbered columns stored in the line memories L3 and L2; a mixer MIX2 for mixing image data corresponding to the even numbered columns stored in the line memories L1 and L2; a line memory L4 in which a line of image data generated by the line memory L3, the line memory L2, and the mixer MIX1 is stored; and a line memory L5 in which a line of image data generated by the line memory L1, the line memory L2, and the mixer MIX2 is stored.

Rows 1 to M in the image signal R(1,1)-R(M,N) is written, row by row, in the line memory L3; the line data of a row is collectively transferred to the line memory L2 immediately before line data of the subsequent row is input to the line memory L3; and the line data of a row transferred to the line memory L2 is further transferred to the line memory L1 before line data of the subsequent row is input to the line memory L2. Once image data of row m−1 is stored in the line memory L1, image data of row m is stored in line memory L2, and image data of row M+1 is stored in line memory L3, at the subsequent timing, the data sets corresponding to odd numbered columns in L2 are directly sent to the line memories L4 and L5 at the same column addresses. At the same time, the image data sets of even numbered columns in the line memories L2 and L3 are sent to the mixer MIX1 to determine the average or weighted average of the image data sets and then sent to the corresponding columns in the line memory L4. The image data sets of even numbered columns in the line memories L1 and L2 are sent to the mixer MIX 2 to determine the average or weighted average of the image data sets and then sent to the corresponding columns in the line memory L5. Then, line data is read out from the line memories L4 and L5 and sent to a selector 88.

Frame switching signals SEL, whose level alternately switches between high and low in each frame, are sent from the control circuit 86 to the selector 88. In the odd numbered frames, line data in the line memory L4, which is mixed image data of row m and row m+1, is selected and, in the even numbered frames, line data in the line memory L5, which is mixed image data of row m and row m−1, is selected. These selected sets of line data are sent to the data-line driving circuit 81. The data-line driving circuit 81 outputs the line data to the data signal line DataR as image data of row m at the timing the control line P1 selects row m.

As the line data of the line memories L4 and L5 is outputted, image data of row m in the line memory L2 is transferred to the line memory L1, and image data of row m+1 in the line memory L3 is transferred to the line memory L2. Then, image data of row m+2 is stored in the line memory L3. This operation is repeated for each row, and, as a result, image data sets of row m+1, m+2, . . . is sent to the data-line driving circuit 81.

The processing circuit 87B for blue (B) operates exactly in the same way as the processing circuit 87R.

For the processing circuit 87G of green (G), the phase of the frame switching signal SEL input to the selector 88 is inverted with respect to that of the processing circuit 87R. That is, in the odd numbered frames, line data in the line memory L5, which is mixed image data of row m and row m−1, is selected, and, in the even numbered frames, line data in the line memory L4, which is mixed image data of row m and row m+1, is selected. Except for that described above, the processing circuit 87G and the processing circuit 87R have the same configuration and operate in the same way.

In this way, the RGB processing circuits 87R, 87G, and 87B alternately generate mixed image data of row m−1 and row m and mixed image data of row m and row m+1 in each frame and send the generated image data to the data-line driving circuit 81. The data-line driving circuit 81 outputs the generated image data as a data signal Vdata to the data signal line Data at the timing of selecting row m and transmits the data signal Vdata to the pixel circuits in row m.

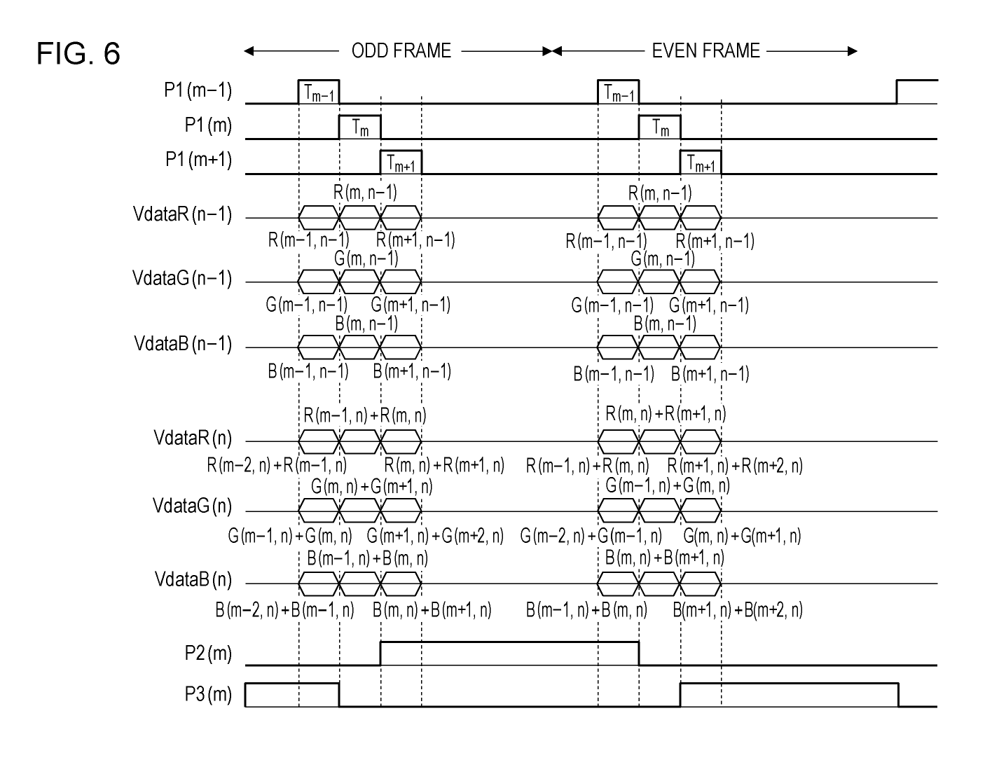

FIG. 6 is a timing chart illustrating the data signals Vdata input to the control lines P1 to P3 and the data signal line D. The P1(m−1), P1(m), and P1(m+1) represent control signals applied to the control lines P1 in rows m−1, m, and m+1. VdataR(n−1), VdataG(n−1), and VdataB(n−1) are data signals respectively transmitted through the RGB data signal lines Data(n−1) in column n−1, and VdataR(n), VdataG(n), and VdataB(n) are data signals respectively transmitted through the RGB data signal lines Data(n) in column n. Here, a column corresponds to a set of RGB. The three pixel circuits in the RGB set are connected to the data signal lines DataR, DataG, and DataB to transmit the data signals VdataR, VdataG, and VdataB, respectively.

The pixel circuits 84 are sequentially selected by the control signals P1(m−1), P1(m), and P1(m+1) of rows m−1, m, and m+1, and the data signals are written in corresponding pixel circuits via the data signal lines of columns n−1 and n.

Writing and illumination of the organic EL elements ELA and ELB are carried out alternately in the next two frames.

After the control signals P2(m) and P3(m) are written in row m in the odd numbered frame, the control line P2 is set to a high level, and the control line P3 remains in a low level. In contrast, after the control signals P2(m) and P3(m) are written in row m in the even numbered frame, the control line P3 is set to a high level, and the control line P2 remains in a low level. The control signals P2 and P3 written in other rows are the same waveforms as the control signals P2(m) and P3(m), except that the timings differs. Therefore, for RGB in both the odd and even numbered columns, the organic EL elements ELA are illuminated in the odd frame, and the organic EL elements ELB are illuminated in the even frame. Among the light-emitting regions illustrated in FIG. 1, the light-emitting regions 31r, 32g, 33b, 34r, 35g, 36b, 41r, 42g, 43b, 44r, 45g, and 46b, which do not include lenses, are illuminated in the odd numbered frame, whereas the light-emitting regions 31R, 32G, 33B, 34R, 35G, 36B, 41R, 42G, 43B, 44R, 45G, and 46B, which are provided with lenses, are illuminated in the subsequent even numbered frame.

The suffix R(m,n) of the data signals in FIG. 6 indicate that the data signal is an R image signal for row m and column n in the original input image signal, which is illustrated in FIG. 5. R(m−1,n)+R(m,n) and G(m+1,n)+G(m,n) each indicate that the data is equivalent to the average of the image data sets of rows m−1 and m and the average of rows m and m+1 in the same column n.

As the data signals VdataR(n−1), VdataG(n−1), and VdataB(n−1) in an odd numbered column (column n−1), the image data sets R(m−1,n−1), G(m−1,n−1), and B(m−1,n−1) of row m−1 are directly transmitted as data signals at the timing of selecting row m−1. Similarly, the image data of row m is directly transmitted at the timing of selecting row m, and the image data of row m+1 is directly transmitted at the timing of selecting row m+1. This is the same in any even and odd numbered frame.

In contrast, a data signal of the even numbered column (column n) is not data directly from the original input image data but is image data converted at the processing circuits 87R, 87G, and 87B.

The VdataR(n) is converted and transmitted in the odd numbered frame into image data corresponding to the average data [R(m−2,n)+R(m−1,n)]/2 of rows m−2 and m−1 at the timing of selecting row m−1, to the average data [R(m−1,n)+R(m,n)]/2 of rows m−1 and m at the timing of selecting row m, and to the average data [R(m,n)+R(m+1,n)]/2 of rows m and m+1 at the timing of selecting row m+1. In FIG. 6, “/2” is omitted.

The VdataR(n) is converted and transmitted in the even numbered frames into image data corresponding to the average data [R(m−1,n)+R(m,n)]/2 of rows m−1 and m at the timing of selecting row m−1, to the average data [R(m,n)+R(m+1,n)]/2 of rows m and m+1 at the timing of selecting row m, and to the average data [R(m+1,n)+R(m+2,n)]/2 of rows m+1 and m+2 at the timing of selecting row m+1.

For VdataG(n), the data of the odd numbered frame and the data of the even number frame are mixed in an opposite way compared to that of VdataR(n). That is, in the odd numbered frame, VdataG(n) is converted and transmitted into image data corresponding to the average data [G(m−1,n)+G(m,n)]/2 of rows m−1 row m at the timing of selecting row m−1, to the average data [G(m,n)+G(m+1,n)]/2 of rows m and m+1 at the timing of selecting row m, and to the average data [G(m+1,n)+G(m+2,n)]/2 of rows m+1 and m+2 at the timing of selecting row m+1; and in the even numbered frame, VdataG(n) is converted and transmitted into image data corresponding to the average data [G(m−2,n)+G(m−1,n)]/2 of rows m−2 and m−1 at the timing of selecting row m−1, to the average data [G(m−1,n)+G(m,n)]/2 of rows m−1 and m at the timing of selecting row m, and to the average data [G(m−1,n)+G(m,n)]/2 of rows m−1 and m at the timing of selecting row m+1.

For VdataB(n), the data of the odd numbered frames and the even number frames are mixed in the opposite way compared with VdataG(n) and thus is the same as VdataR(n). That is, the VdataB(n) is converted and transmitted in the odd numbered frame into image data corresponding to the average data [B(m−2,n)+B(m−1,n)]/2 of rows m−2 and m−1 at the timing of selecting row m−1, to the average data [B(m−1,n)+B(m,n)]/2 of rows m−1 and m at the timing of selecting row m, and to the average data [B(m,n)+B(m+1,n)]/2 of rows m and m+1 at the timing of selecting row m+1; and in the even numbered frame into image data corresponding to the average data [B(m−1,n)+B(m,n)]/2 of rows m−1 and m at the timing of selecting row m−1, to the average data [B(m,n)+B(m+1,n)]/2 of rows m and m+1 at the timing of selecting row m, and to the average data [B(m+1,n)+B(m+2,n)]/2 of rows m+1 and m+2 at the timing of selecting row m+1.

These image data sets are written in the pixel circuits in the selected rows at the specific timings. Input image data corresponding to the row and column of the image pixel in the odd numbered column is directly transmitted and written in the pixel circuit. Accordingly, the organic EL elements ELA and ELB of the two light-emitting regions illuminate in accordance with the image data R(m,n), etc. corresponding to a same pixel in the original image (input image).

However, in the odd numbered frame and the subsequent even numbered frame, the average image data of image data sets corresponding to two different pixels is written in the pixel circuits in the even numbered column, and the organic EL elements ELA and ELB in the two light-emitting regions illuminate with different levels of luminance in the odd and even numbered frames.

Specifically, the image data input to a pixel circuit in the even numbered column is image data (first image data) obtained by mixing image data R(m,n) corresponding to the row and column of the pixel circuit and image data R(m−1, n) corresponding to the previous row and the same column in a frame and, in the next frame, is the image data (second image data) obtained by mixing image data R(m,n) corresponding to the pixel circuit and image data R(m+1,n) corresponding to the next row and the same column. In the RGB pixel circuits constituting a pixel, the phases are reversed in the consecutive frames in which the first image data and the second image data are alternately sent. That is, the first image data is written in the R and B pixel circuits in the odd numbered frame, and the second image data is written in the R and B pixel circuits in the even numbered frame. The second image data is written in the G pixel circuit in the odd numbered frame, and the first image data is written in the even numbered frame.

As illustrated in FIG. 6, since, in the odd numbered frame, the control line P2 is set to a high level after writing data in each row, the image data transmitted in the odd numbered frame determines the electric current applied to the organic EL element ELA and illuminates the organic EL element ELA. Since, in the even numbered frame, the control line P3 is set to a high level after writing data in each row, the image data transmitted in the even numbered frame determines the electric current applied to the organic EL element ELB and illuminates the organic EL element ELB.

When this is applied to the pixel arrangement illustrated in FIG. 1, for R and B, among the organic EL elements ELA and ELB in an even numbered column (column n) in each row, the organic EL elements ELA are disposed in the upper section (closer to the previous row) and are illuminated by the first image data (in the odd numbered frame). The organic EL element ELB disposed in the lower section (closer to the next row) is illuminated by the second image data (in the even numbered frame). In contrast, for G, the organic EL element ELA is disposed in the lower section (closer to the subsequent row) and is illuminated by the second image data (in the odd numbered frame), and the organic EL element ELB is disposed in the upper section (closer to the previous row) and is illuminated by the first image data (in the odd numbered frame). That is, the organic EL elements disposed in the upper section are illuminated by the first image data, and the organic EL elements disposed lower are illuminated by the second image data. For RGB, image data obtained by mixing the image data of a row and the image data of the previous or next row illuminates the organic EL elements near the adjacent row.

An image formed on the display screen by the image data processing described above and the transmission of the image data to the pixel circuits will be described below. For R and B, the image data written in the pixel circuits in an odd numbered column of a row in an odd numbered frame and the image data written in the pixel circuits in the same column in the previous row in an even numbered frame are image data generated from the image data of the same two pixels. For G, the image data written in the pixel circuits in an even numbered column of a row in an odd numbered frame and the image data written in the pixel circuits in the same column in the next row in an even numbered frame are the same image data. Either set of image data is the average of image data sets corresponding to the pixels of the two adjacent rows.

When this is applied to the pixel arrangement illustrated in FIG. 1, the same image data is written in the pixel circuit 44 driving the R light-emitting region 44r at row m and column n and the pixel circuit 34 driving the R light-emitting region 34R at row m−1 and column n in both the odd and even numbered frames, and by writing in the image data, the light-emitting regions 44r and 34R are illuminated. This is the same for the pixel circuit 46 driving the B light-emitting region 46b at row m and column n and the pixel circuit 36 driving the B light-emitting region 36B at the previous row m−1 and column n. The same image data is written in the pixel circuit 35 driving the G light-emitting region 35g at row m−1 and column n and the pixel circuit 45 driving the G light-emitting region 45G at the subsequent row m and column n in both the odd and even numbered frames, and by writing in the image data, the light-emitting regions 35g and 45G are illuminated.

Accordingly, the light-emitting regions 44r and 34R, 35g and 46G, and 46b and 36B are illuminated by the same average image data of rows m−1 and m in the subsequent two frames. The six light-emitting regions illuminated by the same image data constitute one pixel.

In this way, the sets of the three light-emitting regions with lenses in the pixels in the odd numbered and even numbered columns form the delta arrangements 51 and 52 of inverted triangles. The sets of the three light-emitting regions without lenses, which receive the same data as that sent to the three light-emitting regions with lenses, in the pixels in the odd numbered and even numbered columns form the delta arrangements 53 and 55 of regular triangles. As a result, the long triangular delta arrangement 54 formed across two rows, as illustrated in FIG. 14, do not exist, preventing roughness at the edge of the image and providing smooth images.

This is the same for rows m−2 and m−1, and rows m and m+1, and the same relationship holds for the image data corresponding to the subsequent two rows.

Data of the odd numbered frames and data of the subsequent even numbered frames have been described above; the data is also the same for any two consecutive frames such as an even numbered frame and the subsequent odd numbered frame. That is, in even numbered columns, the display of one pixel is always achieved by six light-emitting regions disposed across two adjacent rows. Since the average image data of the image data sets of the two rows is displayed, the ½ pitch shift of the pixels in the odd numbered columns and the even numbered columns is alleviated in the displayed image. Even when an image in which the luminance of the row direction is constant but the luminance of column direction varies is displayed, the luminance varies in the same way in the odd numbered columns and the even numbered columns, providing an image with uniformly varying luminance.

In a still image, the image data for the frames is the same; therefore, the image displayed by organic EL elements ELA in the odd numbered frames and the image displayed by organic EL elements ELB in the even numbered frames are the same. In a movie, similar images are displayed in consecutive frames, except for parts with fast movement. In such a case, the advantages described above are sufficiently achieved.

As described below, by differing the light-emitting period in the odd numbered frames and the even numbered frames, luminance and the view angle can be balanced. Even when an image having high luminance and a narrow view angle and an image having low luminance and a wide view angle are switched, the viewed image does not change; therefore, it is possible to achieve intermediate characteristics by mixing the images.

In the above, the image data of an even numbered column is prepared using the average image data of two rows. Instead, among the two rows, the mixing ratio may be set higher in the image data of the upper row than that of the lower row, or a weighted average may be used by adding a weight, which is greater than the weight of the row selected later, to the data of the row selected first. In either case, it is desirable that image data of the two rows is processed in the same way and is written in the light-emitting region disposed across the two rows.

The difference between odd numbered columns and even numbered columns is relative, and thus the odd and even numbered columns are interchangeable. Among the two different arrangements of the two light-emitting regions in which the vertical positions of the light-emitting regions are inverted, if one of the arrangements is selected for the odd numbered column, the other arrangement is selected for the even numbered column. This is the same for the odd and even numbered frames.

With a monochrome display apparatus, the two types of organic EL elements, one provided with lenses and the other not provided with lenses, are disposed in a square pixel circuit region and are driven by the same pixel circuit. When the present invention is applied to a monochrome display apparatus, the display apparatus may be the same as that described above, except that only R is provided and G and B are not provided.

When only the R organic EL elements ELB have lenses, and G and B organic EL elements ELB do not have lenses and constitute light-emitting regions of different optical characteristics due to the shape and internal structure of the light-emitting regions, the positions of the two light-emitting regions only need to be inverted in accordance with the color cycle, i.e., the RGB cycle, of the pixels and the columns of the pixel circuits do not need to be inverted. In such a case, the transfer timing of the first image data and the second image data of G is set to the same timing as R and B, i.e., the first image data and the second image data are transferred by the same phases of RGB in the even numbered column.

The present invention can be applied to a display apparatus that includes three or more organic EL elements of different organic characteristics connected to one pixel circuit and arranged in an inverted manner in adjacent columns. For a display apparatus including three organic EL elements (ELA, ELB, and ELC), the organic EL element ELA is illuminated in a first frame, the organic EL element ELB is illuminated in a second frame, the organic EL element ELA is illuminated again in a third frame, and the organic EL element ELC is illuminated in a fourth frame, and the image data distribution described above is applied to the first and second frames and the third and fourth frames.

Examples of organic EL elements have been described above; instead, the present invention may also be applied to display apparatuses including light-emitting elements made of inorganic EL material and LEDs.

A detailed structure of the organic EL element used in the present invention and applications of the present invention will be described below.

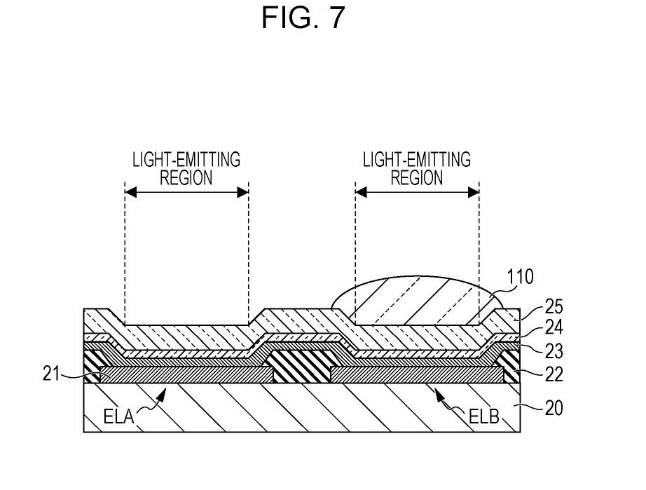

FIG. 7 is a sectional view of organic EL elements ELA and ELB. The organic EL elements ELA and ELB are provided in two light-emitting regions. FIG. 7 illustrates the cross-section of only the R light-emitting region; the sectional structure of G and B light-emitting regions are also the same.

The organic EL elements ELA and ELB each include anode electrodes 21 and a cathode electrode 24, which are a pair, and an organic compound layer 23 (hereinafter referred to as “organic EL layer 23”), which includes a light-emitting layer and is interposed between the electrodes. Each anode electrode 21 is patterned separately in each light-emitting region, and the cathode electrode 24 is shared. An element-region separating layer 22 that separates the organic EL elements is disposed between the organic EL elements.

The anode electrode 21 is made of a conductive metal material having high reflectivity, such as Ag. The anode electrode 21 may be a laminate of a layer made of a metal material and a layer made of a transparent conductive material, such as indium tin oxide (ITO) having an excellent hole injection property.

The cathode electrode 24 is made of a semi-reflective or light-transmissive material. The light generated at the light-emitting layer is extracted to the outside of the element through the cathode electrode. A reflective cathode electrode having a 20% to 80% reflectivity against visible light is formed of a layer with a thickness of 2 to 50 nm and made of a conductive metal material having excellent electron injection property, such as Ag or AgMg.

The organic EL layer 23 includes a single light-emitting layer or multiple layers including a light-emitting layer. An example configuration of the organic EL layer 23 is a four layer structure including a hole transport layer, a light-emitting layer, an electron transport layer, and an electron injection layer or a three layer structure including a hole transport layer, a light-emitting layer, and an electron transport layer. The organic EL layer 23 may be made of known materials.

A base plate 20 has pixel circuits (not shown) for driving the organic EL elements ELA and ELB. Each pixel circuit includes a TFT, a capacitor, wires, and so on.

A protective layer 25 for protecting the organic EL layer 23 from oxygen and moisture in the air is disposed on the cathode electrode 24. The protective layer 25 is made of an inorganic material, such as SiN or SiON, or is a laminated film made of inorganic and organic materials. It is preferable that the protective layer 25 is formed by a CVD method. It is preferable that the film thickness of the inorganic material be in the range of 0.1 μm to 10 μm. By setting the thickness of the protective layer 25 to 1 μm or larger, even if foreign substances that cannot be removed are attached to the surface during production, such foreign substances can be covered.

It is preferable that the protective layer 25 have a flat surface. By using an organic material, it is possible to flatten the surface.

A lens 110 is disposed on the organic EL element ELB. The lens 110 is made by processing resin or inorganic material. The lens can be made by methods such as embossing and photolithography.

Light emitted from the organic EL layer 23 is transmitted through the transparent cathode electrode 24. Then, the light passes through the protective layer 25 and the lens 110 and is emitted to the outside of the organic EL element. Compared to when a lens is not provided, the organic EL element ELB provided with the lens 110 has an emission angle close to an angle vertical to the substrate and is capable of effectively collecting light; therefore, the amount of light emitted to the front of the display apparatus in increased. The emission angle of light that is emitted at an obtuse angle from the light-emitting layer is set to an angle substantially vertical by passing through the lens 110, decreasing the amount of light totally reflected at the emission surface. As a result, the light extraction efficiency is improved.

It is also possible to provide different optical characteristics without using a lens but by changing the thickness of the organic layer and electrode layers in the organic EL elements to provide structural differences in the organic EL elements ELA and ELB.

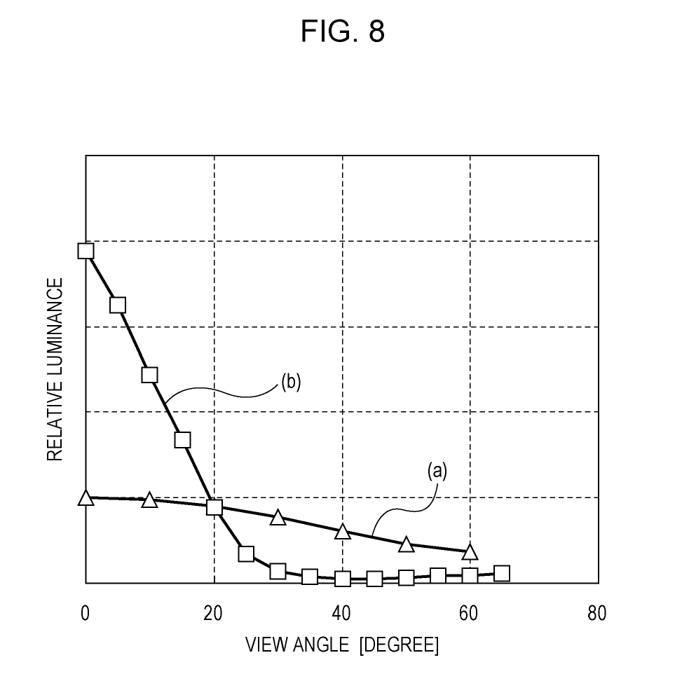

FIG. 8 illustrates the luminance-to-view angle characteristic of (a) the organic EL elements ELA and (b) the organic EL elements ELB. The view angle is zero degrees when viewed from the front. The relative luminance values of the organic EL elements ELA and ELB when they illuminated by the same electric current are illustrated. In the light-emitting region of the organic EL elements ELB, the view angle is narrow, but the front luminance is approximately four times greater than that of the organic EL elements ELA.

To acquire a display with a wide view angle, a display apparatus should include both organic EL elements ELA and ELB, the organic EL elements ELA having a wide view angle should be illuminated, and the organic EL elements ELB having high level front luminance and a narrow view angle should be turned off. In contrast, when the organic EL element ELB is illuminated and the organic EL element ELA is turned off, the front luminance is increased but the view angle becomes narrow.

When a wide view angle is not required, a low power consumption display mode can be entered by illuminating the organic EL elements ELB with a low current and setting the front luminance to that of the organic EL element ELA. By using elements having the characteristics illustrated in FIG. 8, power consumption can be reduced to ¼.

By using two different light-emitting regions having different optical characteristics, provided is a highly flexible display apparatus, which has high display pixel quality and allows switching, in accordance with the user scenes, among various different modes, such as a “high luminance, outdoor visibility mode” having high front luminance, a “wide view angle mode” providing visibility from an angle, and a “low power consumption mode” in which the luminance is decreased in a dark environment.

By switching between the organic EL element ELA and the organic EL element ELB in each frame to achieve an average display, the visible luminance and the view angle may be set to intermediate values of the organic EL element ELA and the organic EL element ELB. The mixing ratio of the characteristics of the organic EL element ELA and the organic EL element ELB can be set by changing the illumination time ratio.

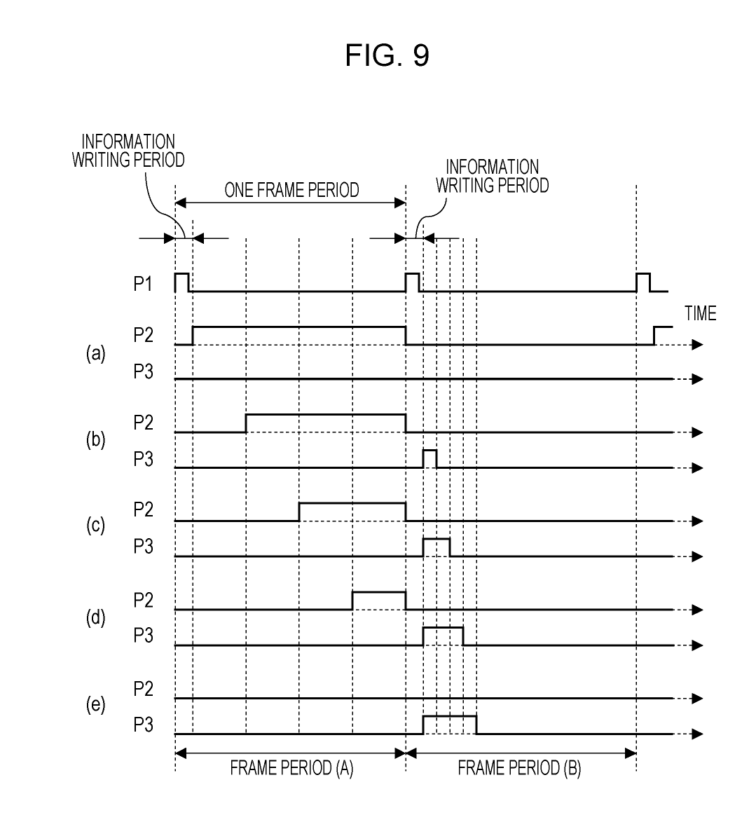

In FIG. 9, (a) to (e) are timing charts of the display apparatus to be illuminated by different light-emitting duties by switching between the organic EL elements ELA and the organic EL elements ELB, which are illustrated in FIG. 8, in each frame. The horizontal axis represents time, and the vertical axis represents timing of turning on (high) and off (low) the elements. The electric current supplied from the pixel circuits are the same at any illumination timing.

The ratio of the illumination time of organic EL element ELA to the illumination time of the organic EL element ELB is 16:0 for (a), 12:1 for (b), 8:2 for (c), 4:3 for (d), and 0:4 for (e). The average luminance from the front is ELA:ELB, which equals 4:0, 3:1, 2:2, 1:3, or 0:4.

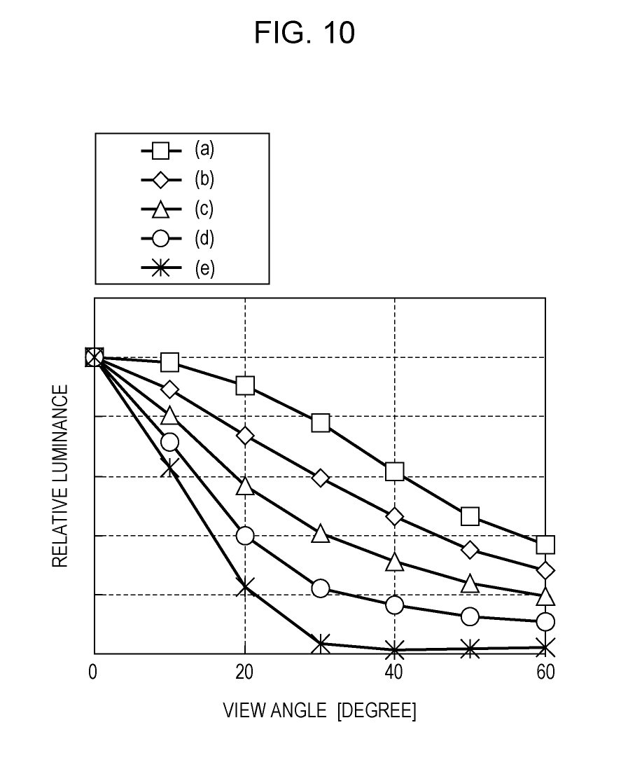

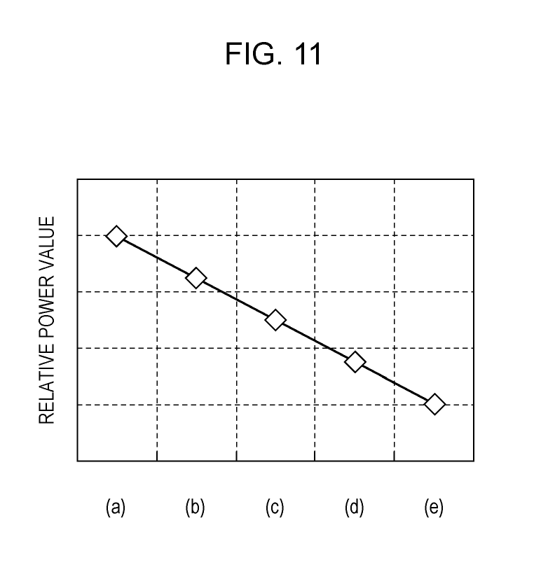

FIG. 10 illustrates the luminance-to-view angle characteristic. FIG. 11 illustrates the relative power consumption. FIG. 10 corresponds to (a) to (e) in FIG. 11, and (a) to (e) in FIG. 9. Through (a) to (e), the front luminance can be gradually reduced while maintaining the front luminance constant. As the view angle is gradually decreased, the power consumption is also gradually decreased.

When the ratio of the illumination time of the organic EL element ELA to the illumination time of the organic EL element ELB is 16:0 for (a), 12:4 for (b), 8:8 for (c), 4:12 for (d), 0:16 for (e), with (a), a “wide view angle mode” in which the front luminance is low but the view angle is wide is entered, and with (e), a “high luminance outdoor visibility mode” that can be used outside because the front luminance is high but the view angle is narrows. (b) to (d) are gradual steps therebetween.

The present invention described above in not limited to a combination of light-emitting regions having lens arrays and light-emitting regions not having lens arrays and may be applied to all types of display apparatuses that include two different types of light-emitting regions having different optical characteristics. The difference in optical characteristics may be set without using lenses but by using interference of optical thin films. The present invention can also be applied to a display apparatus having two different types of light-emitting regions provided with lenses with different diameters or focal lengths and a display apparatus including two different types of light-emitting regions having different optical characteristics by changing the materials and the layer structure of the organic EL elements.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-264219 filed Nov. 26, 2010, which is hereby incorporated by reference herein in its entirety.

What is claimed is:

1. A display apparatus comprising:
a plurality of pixel circuits arranged in a row direction and a column direction;
light-emitting elements each connected to one of the pixel circuits, colors of light emitted from the light-emitting elements being cyclically aligned in the row direction; and
a processing circuit configured to receive image data corresponding to the row and the columns of the pixel circuits by frame period, to process the image data, and to transmit the processed image data to the pixel circuits,
wherein the light-emitting elements each have two light-emitting regions aligned in the column direction so as to invert the positions of the two light-emitting regions in accordance with the cycle of the colors,
wherein the two light-emitting regions have different optical characteristics and emit light alternately over two consecutive frame periods so that the light-emitting regions which emit light in each frame period have the same optical characteristics, and wherein the processing circuit transmits to a portion of the plurality of pixel circuits positioned every two cycles of the colors image data corresponding to the rows and the columns of the pixel circuits to transmit the image data, and to the pixel circuits disposed between the pixel circuits of the portion first image data obtained by mixing image data corresponding to the rows and the columns of the pixel circuits to transmit the first image data with image data corresponding to the previous rows and the same columns and second image data obtained by mixing image data corresponding to the rows and the columns of the pixel circuits to transmit the second image data with image data corresponding to the next rows and the same columns alternately over two consecutive frame periods.

2. The display apparatus according to claim 1, wherein the positions of the two light-emitting regions are inverted in the column direction at every column of the pixel circuits, and wherein the first image data and the second image data alternately transmitted to the pixel circuits disposed between the cycles of the colors are inverted in the pixel circuits in adjacent columns.

3. The display apparatus according to claim 1, wherein the pixel circuits each include a circuit generating an electric current and a switch operated to alternately supply the electric current to the two light-emitting regions.

4. The display apparatus according to claim 1, wherein the first image data is the same as the second image data transmitted to the pixel circuits corresponding to the previous rows and the same columns.

5. The display apparatus according to claim 1, wherein the second image data is the same as the first image data transmitted to the pixel circuits corresponding to the next rows and the same columns.

6. The display apparatus according to claim 1, wherein the two light-emitting regions having different optical characteristics are light-emitting elements having different levels of front luminance and different luminance-to-view angle characteristics.
